(19) United States
(12) Patent Application Publication
(10) Pub. No.: US 2003/0200455 A1
(43) Pub. Date: Oct. 23, 2003

(54) Method applicable to wireless lan for security control and attack detection

(76) Inventor: Chi-Kai Wu, Hsinchu (TW)

Correspondence Address: SUPREME PATENT SERVICES, POST OFFICE BOX 2339, SARATOGA, CA, 95070, US

(21) Appl. No.: 10/126,077

(22) Filed: Apr. 18, 2002

(51) Int. Cl. H04L 9/00

(52) U.S. Cl. 713/200; 380/270

(57) ABSTRACT

A method applicable to wireless LAN for security control and attack detection is firstly like an identity authentication mechanism implemented in a Radius Server, and secondly capable of eliminating the formalities of user authentication adopted by that Radius Server, and thirdly capable of detecting effectively an attack and informing the system manager of the same, or rejecting the request for service from an illegal user.

### FIELD OF THE INVENTION

This invention relates to a method applicable to networks for security control and attack detection, particularly suitable for a wireless Local Area Network (LAN), and the method requires a Dynamic Host Configuration Protocol Server (DHCP Server), an E-mail Server, and a Network Management Console (NMC), in which the NMC is provided with a built-in computer name list of legal users' wireless stations.

### BACKGROUND OF THE INVENTION

An intranet is a small-scale network established and applied in a company or the like for accessing sharable files or communicating internally and is found useless sometimes because of failure in reaching someone in the office who happens to be joining a meeting or leaving temporarily for one reason or another when a salesman or an emergent e-mail is waiting outside and longing for a return instruction. For eliminating such a dead angle, establishment of a wireless network environment is considered an effective remedy.

In the respect of medical care, after a wireless local area network (LAN) has been completed in a hospital, it is possible for a nurse to use a handheld device to transmit voice or data rapidly instead of shuttling back and forth between wards and a nursing station or for a doctor to proceed the remote medical service. In the days lacking a wireless LAN, for answering a phone call, a nurse has to temporarily pause her job at the moment and rush to the nursing station, and when she is answering the call, the line is occupied to reject any coming emergency call that would inevitably affect the intercommunication of the hospital to some extent.

In the event the wireless LAN is available in a hospital, a doctor needs only to carry with himself a PDA on his way of cruising the sickbeds and he can connect the wireless LAN to enter the database of illness history whenever he wants, in which the created waves of IEEE 802.11b wireless LAN would do nothing harm to the medical instruments.

To establish a campus wireless LAN is a milestone for realizing an e-campus. In the architecture of a campus wireless LAN, at least a wireless Access Point is required such that a user might scurry in the wireless LAN with his notebook computer, PDA, portable computer, or any other web connection device, equipped with a piece of wireless network card without needing any entity wire connection or being confined by buildings. In this event, a plurality of wireless Access Points is suggested to promote the outdoor coverage rate to 90% up if possible as the higher the coverage rate is achieved, the much convenience for the users is provided.

The wireless network connection service in a public site is mainly provided in a coffee shop, restaurant, airport for a salesman or SOHO (small office home office) member to talk business or jobs through network without accommodating oneself to a wired phone. In addition, an airport is also a transfer center of businessmen.

It would be no longer peculiar when a policeman is found using a PDA on the street to go web-connecting for checking data of a car license and giving a fine if necessary. Thanks to the promoted availability of web connection in different public sites, all the equipment needed for a user is nothing more than a notebook computer or a PDA mated with a wireless network card to enable him/her to go web-connecting on the spot at a public site addition to a coffee shop, such as a restaurant, airport, gasoline station, convenient store, or security company.

Subsequent to science development and the prevalent network connection, it is about the time point to declare the maturation of the era of home wireless network. In this new era, it is in a progressive present tense instead of a future tense for people to watch a soap opera and meanwhile discuss the scenario thereof in their living room or cook and meanwhile watch the stock prices in kitchen or play online games on a bed or read web stories on a flush toilet, etc. Of course, the applications of a wireless network shall include more, for example, it no longer depends on an entity wiring disposition and can care about mobile requirements concurrently in network connection. However, the wireless network is still weak in its coverage rate, which is controlled by the amount of wireless base station, to hence mainly provide a fixed-point service under a valid mobile speed of 20 km/hr. On the other hand, there are some objective conditions helpful for expanding the population of network connection, including the rapid price decrements of related equipments of the 802.11b wireless network and the built-in network-connection function possessed notebook computer, PDA, and/or projector. In short, a wireless LAN is advantageous to employ an original entity network for sharing resources with a plurality of computers through wireless transmission.

From the viewpoint of a user of highly mobilized products, keeping voice and data in valid communication is always a problem pending improvements, which is solvable now by the wireless LAN technology which is a relay measure ripened toward maturity because of the intricacies of indoors wiring layout of telecommunication industry.

Fortunately, inasmuch as the wireless products of IEEE 802.11b can be used to dissolve abovesaid problems of the entity wiring job, including unstable transmission effect caused by inappropriate wire-laying techniques, so that people might enjoy themselves of the wireless LAN relaxedly owing to its simplified setup and setting formalities, however, the application of IEEE 802.11b is regulated differently depending on specifications.

On the other hand, in substitution for the conventional entity LAN, the wireless network technology standards IEEE 802.11b is fit for setting up a wireless network environment for home use with a transmission speed as high as 11 Mbps and an effective range between 10˜100 m.

Some IEEE 802.11b products are available in market now, including the wireless PCI for desktop computer, the USB wireless network module for desktop and notebook computer, the wireless PCMCIA, etc., which might provide a powerful ability to connect computers in some tens or hundreds for operation in the same time in cooperation with wireless base stations.

The wireless network access made by PC is usually classified in two categories:

(1) On the Basis of IEEE 802.11b Standards

When the SSID and the key value of WEP are found correct, a wireless LAN station is allowed to connect with a desirable wireless base station. In this case, because of some flaws in its practical operation, a hacker might use the tooling software of a wireless LAN packet monitor to intercept wireless LAN packets, in which an invariable key value of WEP is liable to be decrypted by a powerful computer.

(2) On the Basis of a Wireless LAN Supported by the WINDOWS O/S

The IEEE 802.11b wireless network standards are already included in the WINDOWS O/S products, which have the standardized wireless LAN driver defined.

There are four conventional methods applicable to a PC for access of a wireless network as the following:

(1) A First Method Based on the SSID of Beacon Frame

According to the IEEE 802.11b wireless network standards, a wireless base station would periodically send a Beacon frame wirelessly to wireless stations, in which each wireless station will construe the enclosed information upon receipt of the Beacon frame to see whether the wireless base station is a desirable one to connect, and the key value in the frame is SSID, which is hidden in the wireless base station instead of being dispatched. Only a wireless station having a preset application program SSID can connect to that application program when the SSID of the Beacon frame is hidden. Such feature is instrumental for promoting security of a wireless network.

(2) A Second Method Based on the Media Access Control of Stations

According to this invention, all the related wireless stations must have its MAC address logged in the access control list of a wireless base station, otherwise, its request for service would be denied. However, there are still some security loopholes in practical operation because no encryption is applied to the MAC address during transmission, such that a wireless packet monitor can detect to obtain the MAC address.

(3) A Third Method Based on the Key Exchange

This method is basically a concept for replicating a Virtual Private Network (VPN) on the Internet. There is a communication protocol of an automatic Internet Key Exchange (IKE) available according to the Internet network standards, in which the key creation and exchange protocol is specifically defined, a proprietary protocol is defined between a wireless base station and a wireless station, and a new key will be implemented for encoding Wired Equivalent Privacy (WEP) defined in IEEE 802.11. This method is considered weak in compatibility with other IEEE 802.11 products.

(4) A Fourth Method Based on the Radius Server

As IEEE has also built IEEE 802.1x standards for transfer the existing wireless network standards IEEE 802.11 to a Metropolitan Area Network (MAN), such that the product-based IEEE 802.11 technology can be applied to a public domain, such as the Internet access in an airport or train station according to the IEEE 802.1x standards. In addition, the IEEE 802.1x also provides an Authentication Protocol interfaced between a wireless station of portable computer and a Radius Server for accessing a wireless mobile LAN through a wireless base station.

FIG. 1 shows the configuration of a conventional Radius Server 100 having a database 120, in which a name list of legal users is deposited for checking if a new wireless station (computer) 160 is legal or not transmitted by a router 120 through the Internet. Some other devices are connected to the same network, including: wireless base stations 140, 142, 144, wireless stations 160, 162, 164, 166, in which the wireless base station 140 controls the new wireless station 160 as well as the wireless station 162, the wireless base station 142 controls the wireless station 164 and the wireless base station 144 controls the wireless station 166 respectively, and the control is made wirelessly according to the IEEE 802.1x standards.

A Billing System is usually integrated into the Radius Server for an Internet Service Provider (ISP) only, for the reason that entails a relatively great expenditure in setting and maintaining the Radius Server for an average Intranet after all.

### SUMMARY OF THE INVENTION

The primary objective of this invention is firstly to provide a method for security control and attack detection just like an identity authentication mechanism implemented in a Radius Server, and secondly to eliminate the formalities of user authentication adopted by that Radius Server, and thirdly to efficiently detect an attack and inform the system manager of the same, or deny the request for service from any illegal user.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows the configuration of a conventional Radius Server;

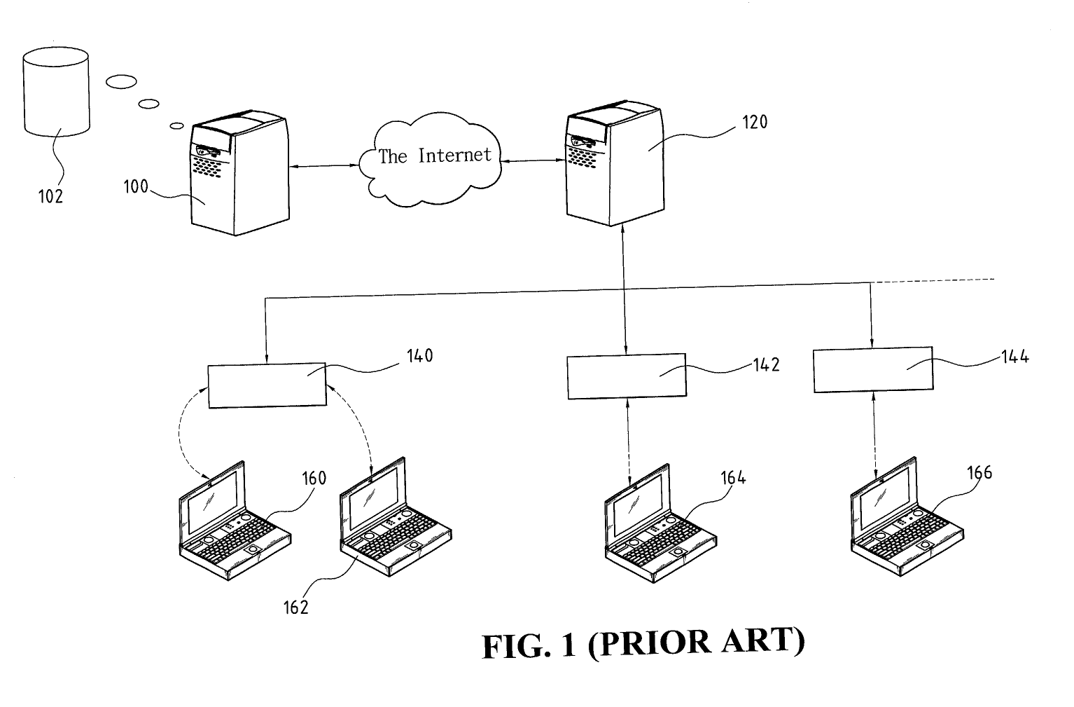

FIG. 2 shows a schematic disposition of this invention applicable to a wireless LAN;

FIG. 3 shows the procedure for operation of a method of this invention; and

FIG. 4 shows the main operating procedure of the method of this invention.

### DETAILED DESCRIPTION OF THE INVENTION

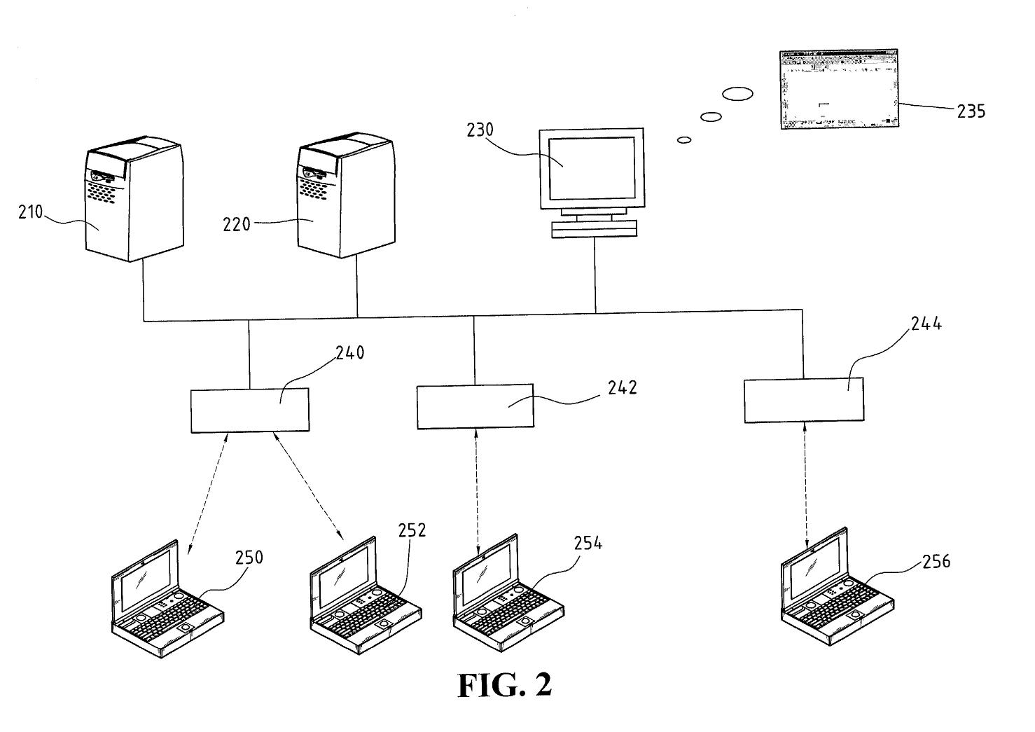

With regard to a method for security control and attack detection of this invention, an applicable wireless Local Area Network (LAN) should comprise at least a wired network and a wireless network as shown in an enclosed FIG. 2.

The applicable wired network is at least comprised of an E-mail Server 210, a Dynamic Host Configuration Protocol Server (DHCP Server) 220, a Network Management Console (NMC) 230, and wireless base stations 240, 242, 244, and all those equipments are connected to a single wired network.

The E-mail Server 210 is implemented to send out E-mails and notify the system manager of a network attack. The DHCP Server 220 is in charge of:

(1) Receiving a request for leasing an Internet Protocol (IP) address from a visitor; and

(2) Providing a most antecedent unoccupied IP address to the visitor upon receipt of such a request broadcasted.

The NMC 230 has to establish a name list of computer of legal users' wireless stations 235 in advance for checking whether a visitor is already a legal wireless subscriber's computer or not to hence provide service or terminate service and notify the system manager of a network attack by way of transmitting an E-mail, video information, or voice.

The NMC 230 is liable for:

(1) Receiving a Standard Network Management Protocol (SNMP) Trap sent from the wireless base station 240, expressing that a new wireless station 250 is joined to this LAN;

(2) Requesting actively the new wireless station 250 for its IP address;

(3) Receiving an information packet of IP address from the new wireless station 250;

(4) Requesting actively the new wireless station 250 for its name of computer;

(5) Receiving an information packet of name of computer from the new wireless station 250; and

(6) Checking if the new wireless station is a legal one with an approved built-in name list of computers of legal wireless stations to thereby via the SNMP make a decision of providing service or interrupting service and notifying the system manager of an attack by an E-mail, video information, or voice.

The applicable wireless network should comprise a plurality of wireless base stations or so-called Access Points 240, 242, 244 for communication with a plurality of wireless stations 250, 252, 254, 256 according to IEEE 802.x wireless communication protocol.

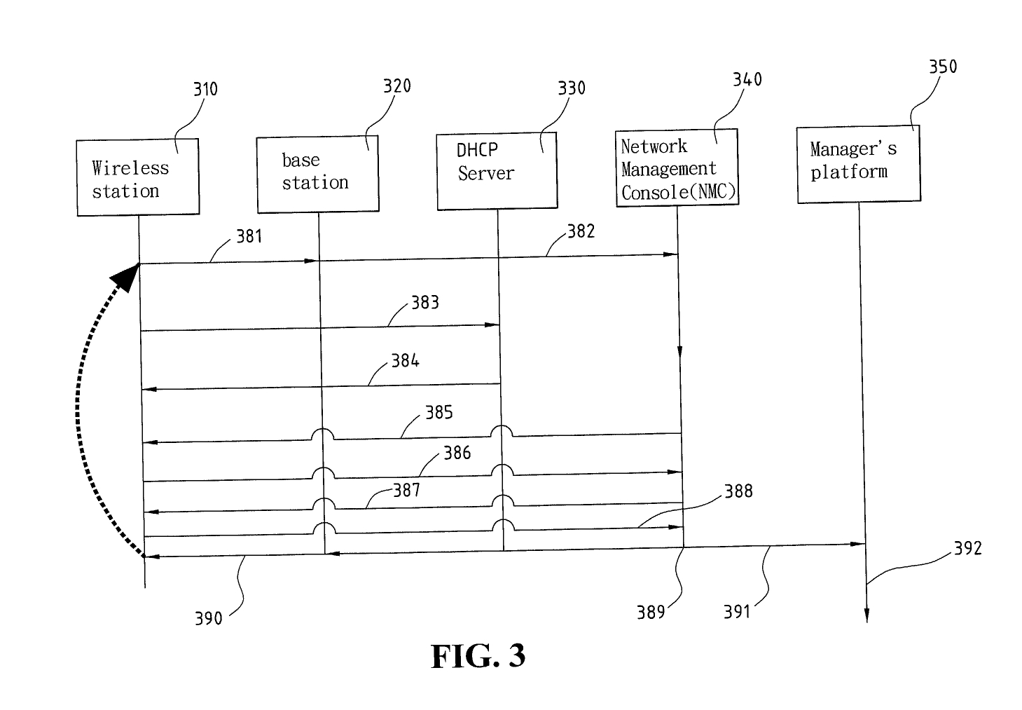

Referring to FIG. 3, the operation procedure of this invention comprises the following steps:

(1) When a new wireless station 310 is found having a correct Service Set Identifier (SSID), a correct key value of the Wired Equivalent Privacy (WEP), and a pre-registered Media Access Control address (MAC address) on the Access Point, an association 381 is to be made between the wireless station 310 and a wireless base station 320 by a Network Management Console (NMC) 340.

(2) The wireless base station 320 is supposed then to export a Standard Network Management Protocol (SNMP) Trap to inform the NMC 340 of the participation of that new wireless station 310.

(3) The new wireless station 310 will actively request a Dynamic Host configuration Protocol Server (DHCP Server) 330 for an IP address 383.

(4) The DHCP Server 380 provides an approved IP address to the new wireless station 310 in return.

(5) The NMC 340 would request the new wireless station 310 for an IP address 385.

(6) The new wireless station 310 reports to the NMC 340 of its IP address 386.

In abovesaid procedure, the step (5) and step (6) might be accomplished by either of the following methods:

(A) Send a request from the NMC 340 for a Reverse Address Resolution Protocol (RARP) Packet having a given Media Access Control address (MAC address). The wireless station 310 would reply to the request with its IP address.

(B) Dispatch a broadcast packet from the NMC 340 to the entire network requesting for IP addresses. All the wireless stations in the network would send their IP addresses back in response so that the NMC 340 might analyze those address packets based on the MAC addresses to thereby find out the IP address of the specified wireless station, and by now, the NMC 340 has the MAC address and IP address of the new wireless station 310.

(7) The NMC 340 would request the new wireless station 310 to report its own computer name 387.

(8) The new wireless station 310 reports its computer name 388 as requested by using a tool program set up on a driver thereof to the NMC 340.

(9) The NMC 340 would check the returned computer name 389 to make sure whether the name is already logged in a legal name list or not, if negative, the NMC is supposed to instruct the wireless base station 320 to deny the request for service of the illegal user (wireless station 310) through the SNMP. Upon receipt of a denial instruction, the wireless base station 320 is to log off all the traffic 390 provided to the wireless station 310, in which the dotted line means that the request for service of the illegal wireless station 310 is refused. Meanwhile, when the illegal wireless station 310 is detected, the NMC 340 would forward a warning message 391 in form of an E-mail to the workstation 350 of a system manager for the latter to update that warning message or beep 392.

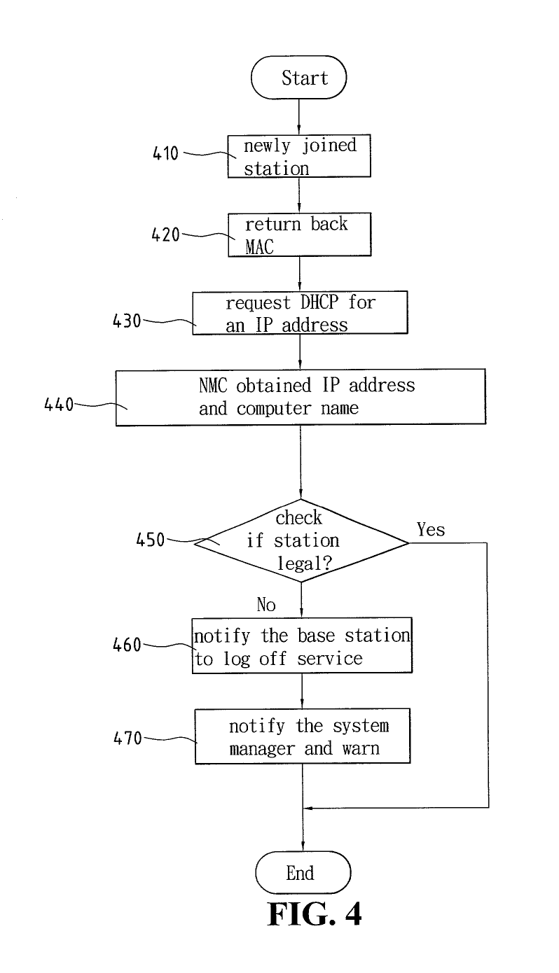

FIG. 4 shows a main procedure flowchart of this invention. In this figure, a first step is to build an association 410 between a new wireless station and a wireless base station when the new wireless station is found having a correct Service Set Identifier (SSID), a correct key value of the Wired Equivalent Privacy (WEP), and a pre-registered Media Access Control address (MAC address) on the Access Point. A second step is that the wireless base station would export a Standard Network Management Protocol (SNMP) Trap and report the MAC address of the new wireless station joined with a wireless LAN 420 to the NMC. A third step is for the new wireless station to request the DHCP Server actively for an IP address, and in response, the DHCP Server is supposed to provide an IP address to the new wireless station 430 if that request is approved. A fourth step is for the NMC to request for the IP address of the new wireless station, which is then supposed to report its IP address to the NMC in return accordingly 440 which can be accomplished by either of the following methods:

(A) The NMC is to dispatch a request for RARP packet having a given MAC address. Then, the associated wireless base station would respond automatically with the IP address of the wireless station upon receipt of the NMC request.

(B) The NMC issues a broadcast packet requesting for IP address to the entire network, and in response, every wireless station in that network would report its own IP address to the NMC for analyzing and finding out the IP address of the specified wireless station according to the MAC address thereof.

Until now, the NMC has the MAC and IP address of the newly joined wireless station, then the NMC would request for the computer name of the wireless station, which is supposed to report its computer name to the NMC in return 440 via a tool program set up on a driver thereof.

A fifth step is for the NMC to check the received computer name and make sure whether it is logged already in a list of legal users 450, if negative, the NMC would instruct the related wireless base station via the SNMP to turn down service to the illegal user, and the wireless base station is to duly log off all the traffic of that illegal wireless station 460. A sixth step is for the NMC to dispatch an E-mail to a workstation of the system manager for updating the warning message or beeping 470 in the event of a detected illegal station.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A method applicable to wireless LAN for security control and attack detection, comprising:
(a) Establishing an association between a new wireless station and a wireless base station by a Network Management Console (NMC) when the new wireless station is found having a correct Service Set Identifier (SSID), a correct key value of the Wired Equivalent Privacy (WEP), and a pre-registered Media Access Control address (MAC address) on an Access Point;
(b) Exporting a Standard Network Management Protocol (SNMP) Trap from the wireless base station to inform the NMC of the participation of the new wireless station;
(c) Dispatching a request from the new wireless station to a Dynamic Host configuration Protocol Server (DHCP Server) for an IP address;
(d) Providing a new IP address from the DHCP Server to the new wireless station in return if the request in step (c) is approved;
(e) Dispatching a request from the NMC to the new wireless station for an IP address;
(f) Reporting to the NMC of the IP address owned by the new wireless station;
in which the steps (e) and (f) are accomplished by either:
(A) Sending a request from the NMC for a Reverse Address Resolution Protocol (RARP) Packet having a given Media Access Control address (MAC address), to which the wireless station would reply with its IP address; or
(B) Dispatching a broadcast packet from the NMC to the entire network requesting for IP addresses, to which All the wireless stations in the network would return with their IP addresses so that the NMC can analyze those address packets based on the MAC addresses to thereby find out the IP address of the specified wireless station, such that the NMC has the MAC address and IP address of the new wireless station;
(g) Dispatching a request from the NMC for computer name so that the new wireless station would report its own computer name in response to the request;
(h) Performing the foregoing report action in step (g) by using a tool program set up on a driver of the new wireless station;
(i) Checking the returned computer name by the NMC to make sure whether the name is already logged in a legal name list or not, if negative, the NMC is supposed to instruct the wireless base station to deny the request for service from the illegal user (wireless station) through the SNMP, and upon receipt of a denial instruction, the wireless base station is to log off all the traffic provided to the wireless station; and
(j) Updating the warning message or beeping or dispatching a warning message in form of an E-mail when the NMC has detected an illegal wireless station.

2. The method according to claim 1, being implemented to connect an E-mail Server, the DHCP Server, the NMC, and a plurality of wireless base stations with the same Local Area Network (LAN) in advance.

3. The method according to claim 1, connecting a plurality of wireless base stations to a plurality of wireless stations through wireless waves and on the basis of IEEE 802.11 communication standards.

4. The method according to claim 1, in which the Network Management Console (NMC) comprises a computer name list of wireless station having at least a legal user.

5. The method according to claim 1, in which the wireless station comprises:
a laptop computer and a related radio frequency communication device;
a notebook computer and a related radio frequency communication device; or
a pocket computer and a related radio frequency communication device.
